(19) United States
(12) Patent Application Publication
(10) Pub. No.: US 2026/0358777 A1
(43) Pub. Date: Nov. 12, 2026

(54) LINE CONFIGURATION CREATION ASSISTANCE DEVICE AND LINE CONFIGURATION CREATION ASSISTANCE METHOD

(71) Applicant: HITACHI, LTD., Tokyo (JP)

(72) Inventors: Kaichiro NISHI, Tokyo (JP); Takahiro NAKANO, Tokyo (JP); Daisuke TSUTSUMI, Tokyo (JP)

(21) Appl. No.: 19/543,171

(22) Filed: Feb. 18, 2026

(30) Foreign Application Priority Data
May 12, 2025 (JP) 2025-079318

(51) Int. Cl. G05B 19/00

(52) U.S. Cl. CPC G05B 19/00; G05B 2219/23

(57) ABSTRACT

A line configuration creation assistance device includes a reference information acquirement unit referring to a line configuration designing knowledge database associating and storing a factor related to a line configuration and a solution with respect to the factor. A parameter relationship database stores a relationship between the input parameters of a line configuration designing device outputting the line configuration. A reference solution is acquired that is the solution with respect to the factor similar to a reception request related to the line configuration and a reference parameter that is the input parameter included in the relationship between the input parameters. A parameter acquirement unit acquires the input parameter to the line configuration designing device satisfying the reception request on the basis of the reception request, the reference solution, the reference parameter, and the input parameter to the line configuration designing device at the time of outputting the present line configuration.

### CROSS-REFERENCE TO RELATED APPLICATION

The present application claims priority from Japanese application JP2025-079318, filed on May 12, 2025, the content of which is hereby incorporated by reference into this application.

### BACKGROUND

The present invention relates to a line configuration creation assistance device and a line configuration creation assistance method that assist the creating or changing of a line configuration.

When a sudden event such as a demand fluctuation and an equipment failure occurs in a manufacturing site, the redesigning and switching of a line configuration are performed. Conventionally, the redesigning and the switching have been performed according to tacit knowledge based on the past finding of a skilled person. However, while the skilled person retires, the skill transfer to a non-skilled person is insufficient, so that the line configuration designing that maintains the quality above the certain level is difficult.

Japanese Patent No. 7615420 discloses a simulation device used by the designer of the line layout of a factory. The simulation device has an interactive type AI function, and the interactive type AI function identifies a function instructed by the designer, and generates a three-dimensional model in which the function is arranged. However, the line configuration is required to be redesigned by the user, and it is difficult for the non-skilled person to use the simulation device.

Japanese Patent No. 7483563 discloses a device assisting the designing of the line configuration. However, there are many input parameters to be set, such as product amount data and the specification data of a production resource, and the cause and effect relationship between the parameters is based on the tacit knowledge of the skilled person. Consequently, it is difficult for the non-skilled person to decide the appropriate combination of the input parameters.

### SUMMARY

By the appearance of large language models, the automation of not only natural language generation, but also of program code generation, has become increasingly widespread. Due to this, it is expected to generate the input parameter based on the request of the user by using the large language model. However, many of the large language models that are commercially used have less knowledge about the production line building and tool, and it is difficult to decide the input parameter for executing the tool.

The present invention has been made in view of such the background, and has an object to provide a line configuration creation assistance device and a line configuration creation assistance method that can improve the efficiency of line designing.

To solve the above-described problems, a line configuration creation assistance device according to the present invention includes: a reference information acquirement unit referring to a line configuration designing knowledge database associating and storing a factor related to a line configuration and a solution with respect to the factor and a parameter relationship database storing a relationship between the input parameters of a line configuration designing device outputting the line configuration and acquiring a reference solution that is the solution with respect to the factor similar to a reception request that is a received request related to the line configuration and a reference parameter that is the input parameter included in the relationship between the input parameters related to the reception request; and a parameter acquirement unit acquiring the input parameter to the line configuration designing device satisfying the reception request on the basis of the reception request, the reference solution, the reference parameter, and a present parameter that is the input parameter to the line configuration designing device at the time of outputting the present line configuration.

According to the present invention, it is possible to provide a line configuration creation assistance device and a line configuration creation assistance method that can improve the efficiency of line designing. Objects, configurations, and effects other than the above will be apparent from the description of the following embodiments.

### BRIEF DESCRIPTION OF THE DRAWINGS

FIG. 1 is a function block diagram of a line configuration creation assistance device according to a first embodiment;

FIG. 2 is a data structure diagram of a line configuration information database according to the first embodiment;

FIG. 3 is a data structure diagram of a line configuration designing knowledge database according to the first embodiment;

FIG. 4 is a data structure diagram of a parameter relationship database according to the first embodiment;

FIG. 5 is a data structure diagram of a reference priority degree database according to the first embodiment;

FIG. 6 is a diagram illustrating an overview of a line configuration creation process according to the first embodiment;

FIG. 7 is a configuration diagram of an input parameter acquiring prompt according to the first embodiment;

FIG. 8 is a configuration diagram of a line configuration creation screen according to the first embodiment;

FIG. 9 is a flowchart of the line configuration creation process according to the first embodiment;

FIG. 10 is a function block diagram of a line configuration creation assistance device according to a second embodiment;

FIG. 11 is a diagram illustrating an overview of a updating process of a reference priority degree database according to the second embodiment;

FIG. 12 is a configuration diagram of an evaluation value acquiring prompt according to the second embodiment;

FIG. 13 is a flowchart of a reference priority degree updating process according to the second embodiment;

FIG. 14 is a configuration diagram of a line configuration creation screen according to the second embodiment;

FIG. 15 is a configuration diagram of a line configuration creation screen displaying new line configuration proposals according to the second embodiment; and

FIG. 16 is a hardware configuration diagram illustrating an example of a computer achieving the functions of the line configuration creation assistance devices according to the above embodiments.

### DETAILED DESCRIPTION

### The overview of a line configuration creation assistance device

A line configuration creation assistance device according to modes (embodiments) for carrying out the present invention will be described below. The line configuration creation assistance device receives a request about a line configuration for product manufacturing, and generates a parameter for generating the line configuration responding to the request, which is inputted to a line configuration designing device. For example, the request is a request changing the present line configuration, and requests the line configuration for maintaining the production amount although an equipment failure occurs.

The line configuration creation assistance device generates a prompt calculating the input parameter in order for the line configuration designing device to output the line configuration satisfying the request. The prompt represents an instruction to a language model server, and includes the input parameter for the case of outputting the present line configuration, the changing case of the line configuration for responding to the request, and the input parameter changed. The line configuration creation assistance device sends the prompt to the language model server to acquire the input parameter, and inputs the input parameter to the line configuration designing device to obtain the line configuration.

By using such the line configuration creation assistance device, the user can obtain the changing proposal of the line configuration by inputting the request. Even a non-skilled person can select the optimum line configuration along the request by comparing a plurality of changing proposals.

### The configuration of the line configuration creation assistance device

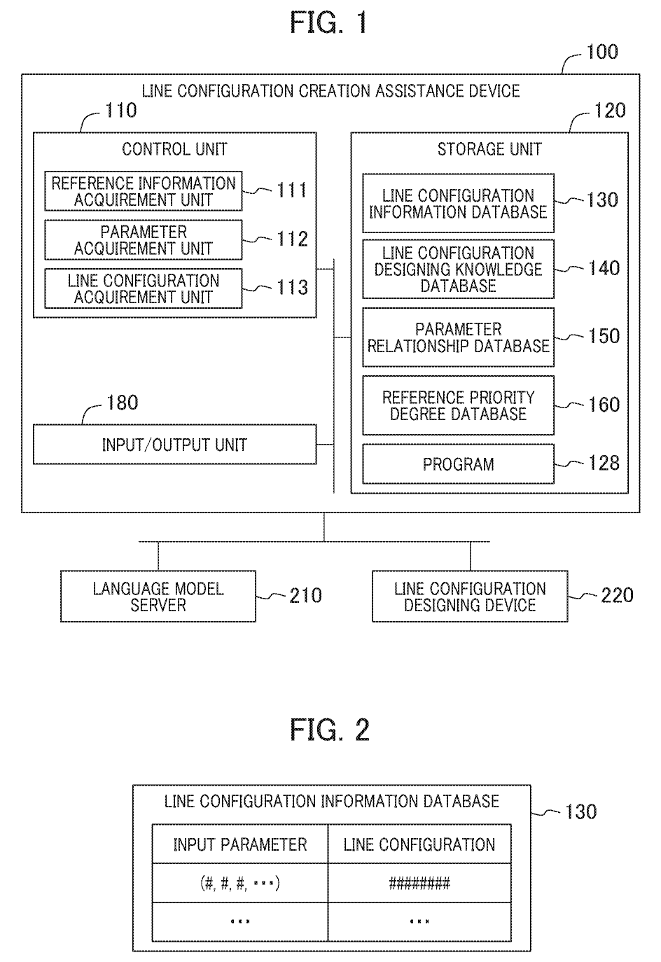

FIG. 1 is a function block diagram of a line configuration creation assistance device 100 according to a first embodiment. The line configuration creation assistance device 100 is a computer, and includes a control unit 110, a storage unit 120, and an input/output unit 180. To the input/output unit 180, a user interface device, such as a display, a keyboard, and a mouse is connected. The input/output unit 180 includes a communication device, and enables data transmission and reception to and from a language model server 210 and a line configuration designing device 220.

The language model server 210 is a server providing a service called a generation AI chatbot and the like. The language model server 210 receives a request/instruction called a prompt from the line configuration creation assistance device 100, and creates a reply by using a language model for replying. The prompt is a text in a natural language, but may include a text representing a graph structure.

The line configuration designing device 220 generates the configuration of a manufacturing line (also simply referred to as a line) on the basis of an input parameter. Examples of the input parameter include the arrangeable number of cells, the maximum number of lines, the maximum number of cells of the line, the minimum number of workers, a production amount, a target cycle time, an operation time, a labor cost, and the like.

### The line configuration creation assistance device: The storage unit

The storage unit 120 is configured to include a storage device, such as a ROM (Read Only Memory), a RAM (Random Access Memory), and an SSD (Solid State Drive). The storage unit 120 stores a line configuration information database 130, a line configuration designing knowledge database 140, a parameter relationship database 150, a reference priority degree database 160, and a program 128. The program 128 includes the description of the process executed by the functioning unit included in the control unit 110 described later. It should be noted that for various storage contents of the storage unit 120, the storage contents stored in an external storage device such as a cloud server may be read, as needed.

### The storage unit: The line configuration information database

FIG. 2 is a data structure diagram of the line configuration information database 130 according to the first embodiment. The line configuration information database 130 is, for example, data in table form. One row (record) of the line configuration information database 130 includes the columns (attributes) of the value of the input parameter to the line configuration designing device 220 (see FIG. 1) and the outputted line configuration. The record may include the column of a day and time when the line configuration is outputted or a day and time when the line configuration is operated.

### The storage unit: The line configuration designing knowledge database

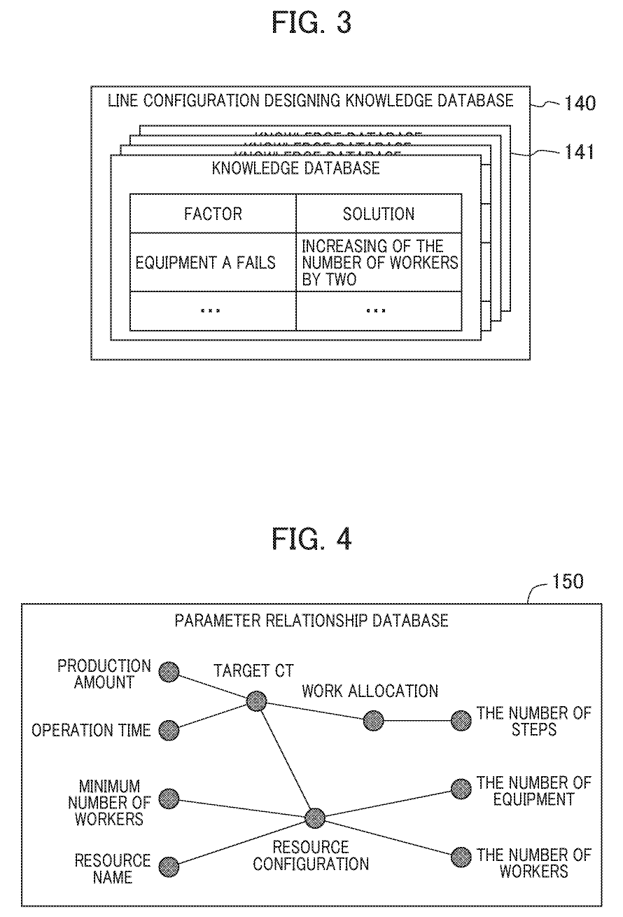

FIG. 3 is a data structure diagram of the line configuration designing knowledge database 140 according to the first embodiment. The line configuration designing knowledge database 140 includes one or more knowledge databases 141. For example, the knowledge database 141 is provided according to the type of a product, a manufacturing method, the country and area of a manufacturing factory, and the like.

The knowledge database 141 is, for example, data in table form. One row (record) of the knowledge database 141 includes the columns (attributes) of a factor and a solution.

The factor is a factor or a cause creating or changing the line configuration. Examples of the factor include an event such as “The failure of the equipment A” and a request, such as “The number of workers is up to 50.”, “The production amount is increased to 100 pieces/day.”, and “The upper limit of the investment amount is one hundred million yen.”. In addition, the factor may include the cause and the request like “Although the equipment A fails, the production amount is desired to be maintained.”.

The solution is a response with respect to the factor. The response is not limited to the changing of the line configuration itself, and is also related to the worker operating in the line. The solution with respect to the factor of “The failure of the equipment A” is not limited to “The repairing of the equipment A”, and includes, for example, “The increasing of the number of workers by two”. The solution may be the reducing of the number of workers and the replacing of the worker.

The factor and the solution are the factor included in the event occurring in the past and the request and the solution performed for responding to the factor. In addition, the factor and solution may be the solution with respect to the factor assumed.

The content of the knowledge database 141 for the case where the knowledge database 141 is provided according to the type of the product will be supplemented. For example, when the product is an automobile, the worker and the robot operate together, but when the product is a battery, the operation in which the number of workers is small and the manufacturing apparatus is predominant is performed. Thus, for the event of worker absence, the knowledge database 141 of the product as the automobile includes many factors and solutions related to the worker.

On the other hand, in the knowledge database 141 of the product as the battery, not many factors and solutions related to the worker are included. Thus, for the solution with respect to the factor of “Two workers are absent.”, it is ideal that the knowledge database 141 of the battery is not referred. A reference priority degree representing which knowledge database 141 is referred on a priority basis will be described later.

Each of the factor and the solution is stored as a text in FIG. 3, but may be stored, as an embedded expression, in the form of a numerical value vector, or both of the text and the embedded expression may be stored.

As described above, the line configuration creation assistance device 100 stores the line configuration designing knowledge database 140 associating and storing the factor related to the line configuration and the solution with respect to the factor.

The line configuration designing knowledge database 140 is divided into one or more knowledge databases 141.

The solution includes at least one of the changing of the line configuration, the increasing of the number of workers in the line, the reducing of the number of workers, and the replacing of the worker.

### The storage unit: The parameter relationship database

FIG. 4 is a data structure diagram of the parameter relationship database 150 according to the first embodiment. The parameter relationship database 150 stores the dependence relationship or the cause and effect relationship between the input parameters of the line configuration designing device 220. For example, the production amount has the dependence relationship or the cause and effect relationship with the target cycle time (Cycle Time, CT). The parameter relationship database 150 may store a mathematical equation established between the input parameters. As the example of the mathematical equation, the production amount=the operation time/the target cycle time is present. Hereinbelow, the dependence relationship or the cause and effect relationship between the input parameters will be simply referred to as a relationship.

As described above, the line configuration creation assistance device 100 stores the parameter relationship database 150 storing a relationship between the input parameters of the line configuration designing device 220 outputting the line configuration.

### The storage unit: The reference priority degree database

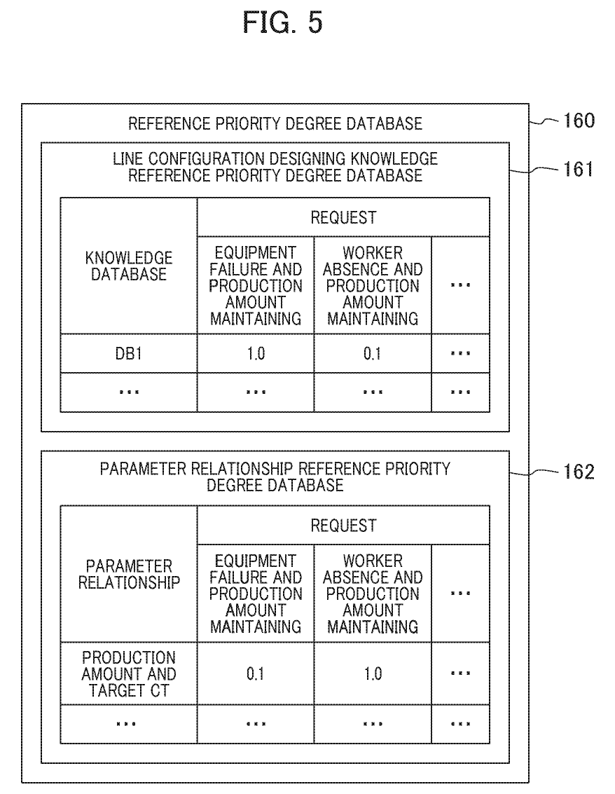

FIG. 5 is a data structure diagram of the reference priority degree database 160 according to the first embodiment. The reference priority degree database 160 includes a line configuration designing knowledge reference priority degree database 161, and a parameter relationship reference priority degree database 162.

The line configuration designing knowledge reference priority degree database 161 is, for example, data in table form, and represents the priority degree (reference priority degree) referring to the knowledge database 141 (see FIG. 3) responding to the request with respect to the line. The request has the content of the request with respect to the line configuration inputted to the line configuration creation assistance device 100. Examples of the content of the request include “Equipment failure and production amount maintaining” with respect to the request of “Although the equipment fails, the production amount is desired to be maintained.”, and “Worker absence and production amount maintaining” with respect to the request of “Although the worker is absent, the production amount is desired to be maintained.”.

In addition, examples of the content of the request for the case where the knowledge database 141 is provided according to the type of the product and the country/area of the manufacturing factory include “The response to equipment failure in the battery manufacturing line” responding to the request of “Since the equipment A in the battery manufacturing line fails, it is desired to be urgently responded.”, and “The response to worker absence in the X factory” responding to the request of “Since the worker is absent in the X factory, its response is desired to be recognized.”. It should be noted that here, the X represents the country or the area. The reference and the reference priority degree of the knowledge database 141 will be described later.

The parameter relationship reference priority degree database 162 is, for example, data in table form, and represents the priority degree (reference priority degree) referring to the parameter relationship database 150 (see FIG. 4) responding to the request with respect to the line. The reference and the reference priority degree of the parameter relationship database 150 will be described later.

As described above, the line configuration creation assistance device 100 stores the reference priority degree database 160 storing the reference priority degree (see the line configuration designing knowledge reference priority degree database 161) that is the priority degree referring to each knowledge database 141 for each request content that is the content of the request and the reference priority degree (see the parameter relationship reference priority degree database 162) that is the priority degree referring to each relationship between the input parameters stored in the parameter relationship database 150 for each request content.

### The line configuration creation assistance device: The control unit

Returning to FIG. 1, the control unit 110 will be described. The control unit 110 is configured to include a CPU (Central Processing Unit), and includes a reference information acquirement unit 111, a parameter acquirement unit 112, and a line configuration acquirement unit 113. The control unit 110 may be configured to include a GPU (Graphics Processing Unit), an NPU (Neutral (network) Processing Unit), an FPGA (Field Programmable Gate Array), an ASIC (Application Specific Integrated Circuit), and the like.

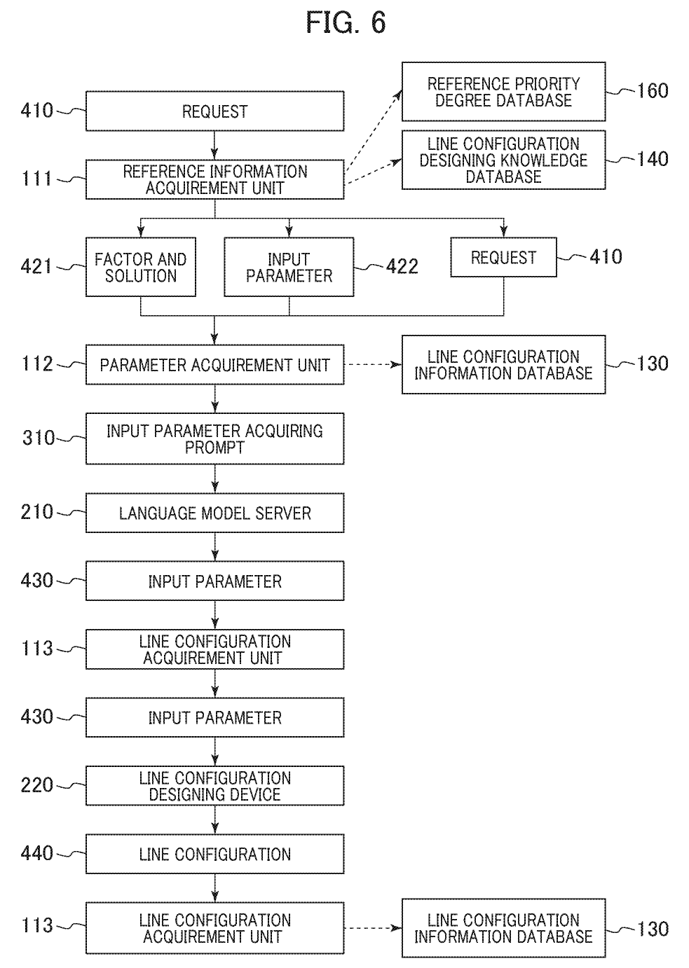

FIG. 6 is a diagram illustrating the overview of a line configuration creation process according to the first embodiment. Referring to FIG. 6, the reference information acquirement unit 111, the parameter acquirement unit 112, and the line configuration acquirement unit 113 will be described.

### The control unit: The reference information acquirement unit

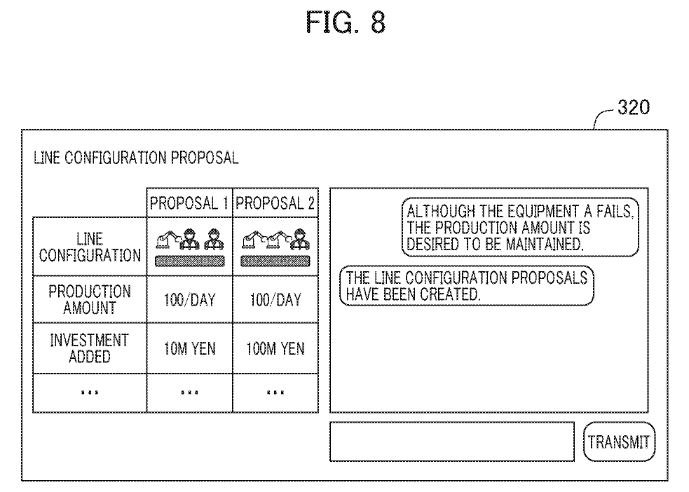

The reference information acquirement unit 111 receives a request 410 inputted to the line configuration creation assistance device 100. It should be noted that the request 410 is inputted via a line configuration creation screen 320 (see FIG. 8) described later. As the example of the request 410, “Although the equipment A fails, the production amount is desired to be maintained.” is present.

Next, the reference information acquirement unit 111 acquires a factor and solution 421 responding to the request 410, and an input parameter 422 to the line configuration designing device 220 related to the request 410. For example, the input parameter 422 related to the request 410 is the name/identification information of the input parameter assumed to be required to be adjusted in order to respond to the request changing the line configuration. When acquiring the factor and solution 421 and the input parameter 422, the reference information acquirement unit 111 refers to the reference priority degree database 160 (see FIG. 5), and refers to the knowledge database 141 and the parameter relationship in which the reference priority degree of the request similar to the request 410 is high. This will be described below in detail.

The reference information acquirement unit 111 identifies the request similar to the request 410 among the requests included in the line configuration designing knowledge reference priority degree database 161. Being similar means that the cosine similarity degree between the numerical value vectors as the embedded expressions of the texts representing two requests is a predetermined similarity degree or more. Next, the reference information acquirement unit 111 identifies the knowledge database 141 in which the reference priority degree of the identified request is the predetermined reference priority degree or more.

For example, it is assumed that the similarity degree between the request 410 of “Although the equipment A fails, the production amount is desired to be maintained.” and the request of “Equipment failure and production amount maintaining” in the line configuration designing knowledge reference priority degree database 161 is the predetermined similarity degree or more. Then, the reference information acquirement unit 111 identifies the knowledge database 141 in which the reference priority degree is the predetermined reference priority degree or more in the column of “Equipment failure and production amount maintaining” of the line configuration designing knowledge reference priority degree database 161. If the predetermined reference priority degree is 0.9, the reference information acquirement unit 111 identifies the knowledge database 141 of “DB1” in which the reference priority degree is “1.0”. It should be noted that a plurality of the knowledge databases 141 may be identified.

Subsequently, the reference information acquirement unit 111 acquires the factor in which the factor is similar to the request 410 and its solution in the identified knowledge database 141 (see FIG. 3). In this case, the reference information acquirement unit 111 may acquire the portion of the factor or the cause in the request 410, and may compare the portion with the factor of the knowledge database 141. For example, the reference information acquirement unit 111 acquires the factor of “The equipment A fails.” from the request 410 of “Although the equipment A fails, the production amount is desired to be maintained.”, and compares the factor with the factor of the knowledge database 141 to acquire the similar factor. It should be noted that being similar means that the cosine similarity degree between the numerical value vectors as the embedded expressions of the texts representing two factors is the predetermined similarity degree or more.

Until here, the present invention has been described by taking the request 410 of “Although the equipment A fails, the production amount is desired to be maintained.” as an example. As the example of the request 410 including the product in the line, “Since the equipment A in the battery manufacturing line fails, it is desired to be urgently responded.” is present. The line configuration designing knowledge reference priority degree database 161 stores the reference degree according to the product, and when the product is included in the request 410, the reference information acquirement unit 111 refers to the knowledge database 141 corresponding to the product. For example, the reference information acquirement unit 111 identifies the knowledge database 141 corresponding to “The response to equipment failure in the battery manufacturing line”, and acquires the factor in which the factor is similar to the request 410 and its solution in the identified knowledge database 141.

In addition, as the example of the request 410 including the country and area of the factory, “Although the worker is absent in the X factory, its response is desired to be recognized.” is present. The line configuration designing knowledge reference priority degree database 161 stores the reference degree according to the country and area of the factory, and when the factory is included in the request 410, the reference information acquirement unit 111 refers to the knowledge database 141 corresponding to the country and area of the factory. For example, the reference information acquirement unit 111 identifies the knowledge database 141 corresponding to “The response to worker absence in the X factory”, and acquires the factor in which the factor is similar to the request 410 and its solution in the identified knowledge database 141.

Next, the parameter relationship reference priority degree database 162 (see FIG. 5) will be described. The reference information acquirement unit 111 identifies the request similar to the request 410 among the requests included in the parameter relationship reference priority degree database 162. Next, the reference information acquirement unit 111 acquires the input parameter included in the parameter relationship in which the reference priority degree of the identified request is the predetermined reference priority degree or more. Since the parameter relationship is included in the parameter relationship database 150, the reference information acquirement unit 111 refers to the parameter relationship database 150.

For example, it is assumed that the similarity degree between the request 410 of “Although two workers are absent, the production amount is desired to be maintained.” and “Worker absence and production amount maintaining” in the parameter relationship reference priority degree database 162 is the predetermined similarity degree or more. Then, the reference information acquirement unit 111 identifies the parameter relationship in which the reference priority degree is the predetermined reference priority degree or more in the column of “Worker absence and production amount maintaining” of the parameter relationship reference priority degree database 162. If the predetermined reference priority degree is 0.9, the reference information acquirement unit 111 identifies the parameter relationship of “Production amount and target cycle time” in which the reference priority degree is “1.0”. Subsequently, the reference information acquirement unit 111 acquires the input parameter of “Production amount” and “Target cycle time” from the parameter relationship. It should be noted that a plurality of parameter relationships may be identified.

The reference information acquirement unit 111 outputs the acquired factor and solution 421, input parameter 422, and request 410 to the parameter acquirement unit 112.

It should be noted that the predetermined reference priority degree for the case of identifying the knowledge database 141 and the predetermined reference priority degree for the case of acquiring the parameter relationship may have the same value or may have different values.

As described above, the line configuration creation assistance device 100 includes the reference information acquirement unit 111 referring to the line configuration designing knowledge database 140 and the parameter relationship database 150.

The reference information acquirement unit 111 acquires the reference solution (see the factor and solution 421) that is the solution with respect to the factor similar to the reception request that is the received request 410 related to the line configuration and the reference parameter that is the input parameter 422 included in the relationship between the input parameters related to the reception request.

The reference information acquirement unit 111 refers to the reference priority degree database 160 (in which the line configuration designing knowledge reference priority degree database 161 is included), decides the knowledge database 141 in which the reference priority degree with respect to the request content similar to the reception request is the predetermined value or more, and refers to the knowledge database 141 to acquire the reference solution (see the factor and solution 421).

The reference information acquirement unit 111 refers to the reference priority degree database 160 (in which the parameter relationship reference priority degree database 162 is included), decides the relationship between the input parameters in which the reference priority degree with respect to the request content similar to the reception request is the predetermined value or more, and refers to the relationship between the input parameters to acquire the reference parameter (see the input parameter 422).

### The control unit: The parameter acquirement unit

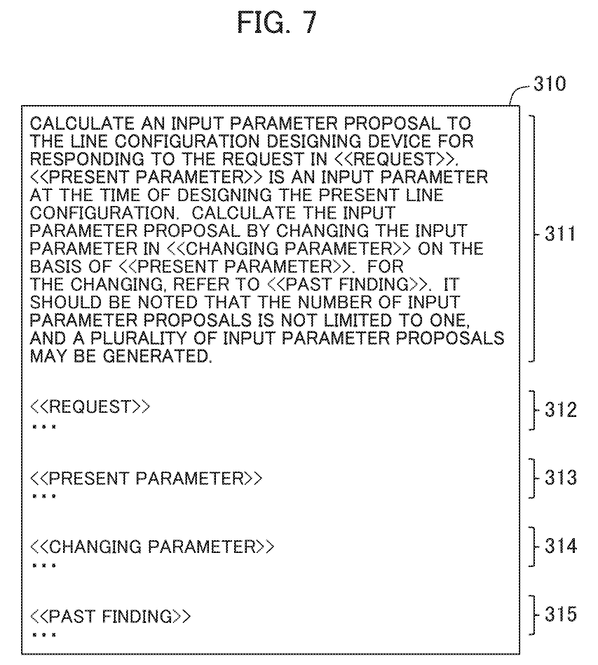

The parameter acquirement unit 112 receives the factor and solution 421, the input parameter 422, and the request 410, and generates an input parameter acquiring prompt 310. FIG. 7 is a configuration diagram of the input parameter acquiring prompt 310 according to the first embodiment. An element 311 includes an instruction calculating the input parameter value of the line configuration designing device 220 for responding to the request in an element 312. The instruction includes an instruction calculating the input parameter value of the line configuration designing device 220 by changing the input parameter in an element 314 on the basis of the input parameter value at the time of creating the present line configuration in an element 313. In addition, the instruction includes an instruction referring to the past finding in an element 315.

The request of the element 312 is the inputted request 410.

The present parameter of the element 313 is the input parameter value when the line configuration designing device 220 creates the present line configuration. It should be noted that the parameter acquirement unit 112 refers to the line configuration information database (see FIG. 2), and acquires the input parameter value at the time of creating the present line configuration.

The changing parameter of the element 314 is the input parameter 422.

The past finding of the element 315 is the factor and solution 421.

Returning to FIG. 6, the description of the parameter acquirement unit 112 will be continued. The parameter acquirement unit 112 transmits the generated input parameter acquiring prompt 310 to the language model server 210, acquires an input parameter 430 (input parameter value) as the reply, and outputs the input parameter 430 to the line configuration acquirement unit 113. The number of input parameters (input parameter sets) is not limited to one, and there may also be a plurality of input parameters (input parameter sets).

As described above, the line configuration creation assistance device 100 includes the parameter acquirement unit 112 acquiring the input parameter 430 to the line configuration designing device 220 satisfying the reception request (see the request 410) on the basis of the reception request (see the request 410), the reference solution (see the factor and solution 421), the reference parameter (see the input parameter 422), and the present parameter that is the input parameter to the line configuration designing device 220 at the time of outputting the present line configuration.

The parameter acquirement unit 112 includes the reception request, the reference solution, the reference parameter, and the present parameter, refers to the reference solution to generate the input parameter acquiring prompt 310 performing instruction to calculate the input parameter to the line configuration designing device 220 satisfying the reception request by changing the reference parameter on the basis of the present parameter, and transmits the input parameter acquiring prompt 310 to the language model server 210 to acquire the input parameter 430 as the reply.

### The control unit: The line configuration acquirement unit

The line configuration acquirement unit 113 transmits the received input parameter 430 to the line configuration designing device 220, and acquires a line configuration 440. The line configuration acquirement unit 113 stores the input parameter 430 and the line configuration 440 into the line configuration information database 130. Next, the line configuration acquirement unit 113 displays the overview of the acquired line configuration on the line configuration creation screen 320.

FIG. 8 is a block diagram of the line configuration creation screen 320 according to the first embodiment. On the left side of the line configuration creation screen 320, the overview of the line configuration as the changing proposal acquired by the line configuration acquirement unit 113 is displayed. The overview includes the equipment in the line, the worker, the production amount, the investment money amount added, and the like.

In the region on the right side of the line configuration creation screen 320, the user and the line configuration creation assistance device 100 interact in chat form. The first message of “Although the equipment A fails, the production amount is desired to be maintained.” is the request 410 inputted by the user.

The user inputs the request 410 with respect to the changing proposal (line configuration proposal) to the textbox on the lower right side of the line configuration creation screen 320, and can further change the changing proposal. It should be noted that the present parameter of the element 313 of the input parameter acquiring prompt 310 (see FIG. 7) with respect to the request of the changing proposal is the input parameter 430 at the time of acquiring the changing proposal.

### The line configuration creation process

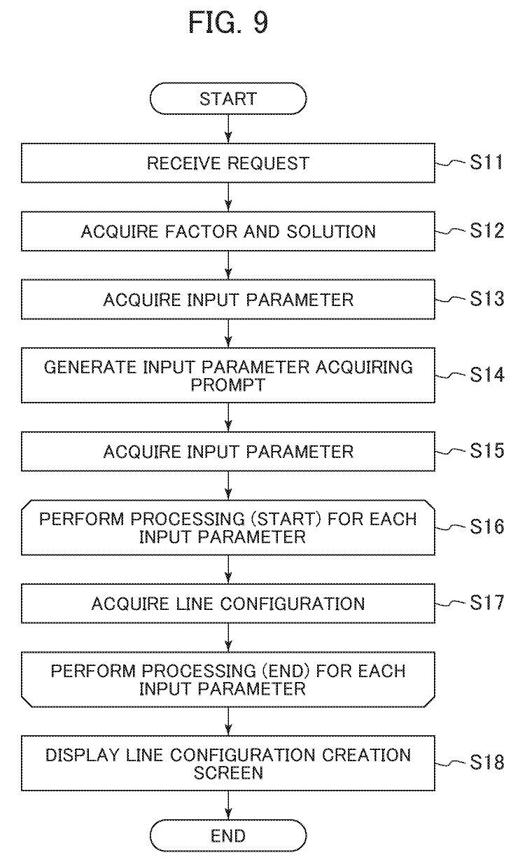

FIG. 9 is a flowchart of the line configuration creation process according to the first embodiment. Referring to FIG. 9, the process until the line configuration proposal with respect to the inputted request of the line configuration is outputted will be described.
In step S11, the reference information acquirement unit 111 receives the request 410 (see FIG. 6) via the line configuration creation screen 320 (see FIG. 8).
In step S12, the reference information acquirement unit 111 acquires the factor and solution 421 responding to the request 410.
In step S13, the reference information acquirement unit 111 acquires the input parameter 422 related to the request 410.
In step S14, the parameter acquirement unit 112 generates the input parameter acquiring prompt 310 (see FIG. 7).
In step S15, the parameter acquirement unit 112 transmits the input parameter acquiring prompt 310 to the language model server 210, and acquires the input parameter 430 as the reply.
In step S16, the line configuration acquirement unit 113 starts the process repeating step S17 for each input parameter 430 acquired in step S15.
In step S17, the line configuration acquirement unit 113 transmits the input parameter 430 to the line configuration designing device 220, and acquires the line configuration 440. The line configuration acquirement unit 113 stores the input parameter 430 and the line configuration 440 into the line configuration information database 130.
In step S18, the line configuration acquirement unit 113 displays the overview of the line configuration on the line configuration creation screen 320 (see FIG. 8).

### The features of the line configuration creation assistance device

The line configuration creation assistance device 100 acquires the factor and solution responding to the inputted request and the input parameter of the line configuration designing device 220 related to the request. The line configuration creation assistance device 100 generates the input parameter acquiring prompt 310 including the factor and solution and the input parameter, and transmits the input parameter acquiring prompt 310 to the language model server 210 to acquire the input parameter proposal. Subsequently, the line configuration creation assistance device 100 transmits the input parameter proposal to the line configuration designing device 220, and acquires the line configuration proposal.

By using such the line configuration creation assistance device 100, the user can obtain the changing proposal of the line configuration by inputting the request. Even a non-skilled person can select the optimum line configuration along the request by comparing a plurality of changing proposals.

The line configuration creation assistance device 100 identifies the knowledge database 141 and the parameter relationship referred according to the request, and acquires the factor and solution and the input parameter. As compared with the case where all the past solutions and all the input parameters are referred, the input parameter acquiring prompt 310 including the appropriate input parameter to be changed and solution can be generated. Further, the appropriate input parameter proposal can be acquired, and it can be expected that the line configuration proposal is obtained.

### Second Embodiment

In the first embodiment, the reference priority degree included in the reference priority degree database 160 (see FIG. 5) has been previously set. The reference priority degree may be updated on the basis of the evaluation of the user with respect to the line configuration proposal (changing proposal).

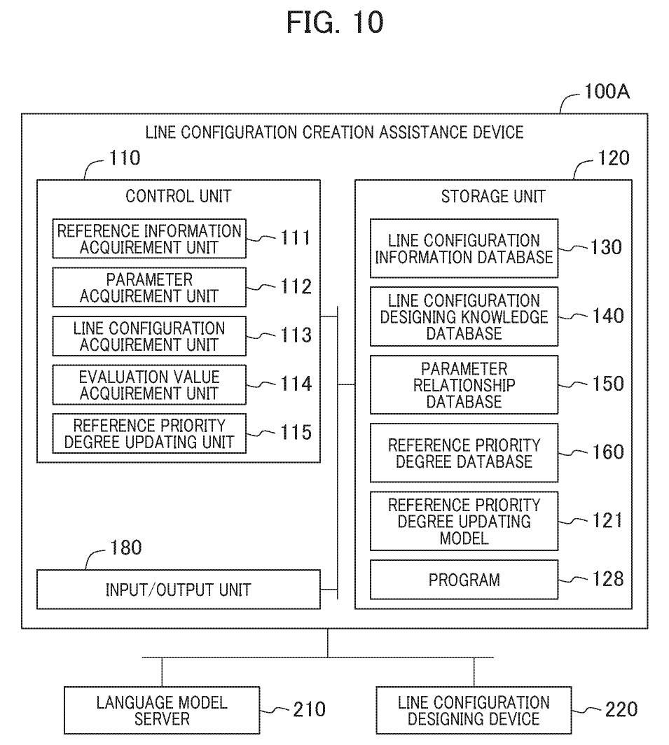

FIG. 10 is a function block diagram of a line configuration creation assistance device 100A according to the second embodiment. As compared with the line configuration creation assistance device 100 (see FIG. 1) according to the first embodiment, the control unit 110 of the line configuration creation assistance device 100A is added with an evaluation value acquirement unit 114 and a reference priority degree updating unit 115. In addition, the storage unit 120 is added with a reference priority degree updating model 121.

### The second embodiment: The reference priority degree updating model

The reference priority degree updating model 121 is a machine learning model referred when the reference priority degree database 160 is updated on the basis of the evaluation with respect to the line configuration proposal. For example, the reference priority degree updating model 121 is the machine learning model of a reinforcement learning technique having a state including the reference priority degree database 160, the line configuration, and the inputted request, a reward being an evaluation with respect to the line configuration proposal, and an action being the decision of the changing target and the changing width of the reference priority degree database 160. The action can also be said to be the updating of the reference priority degree database 160.

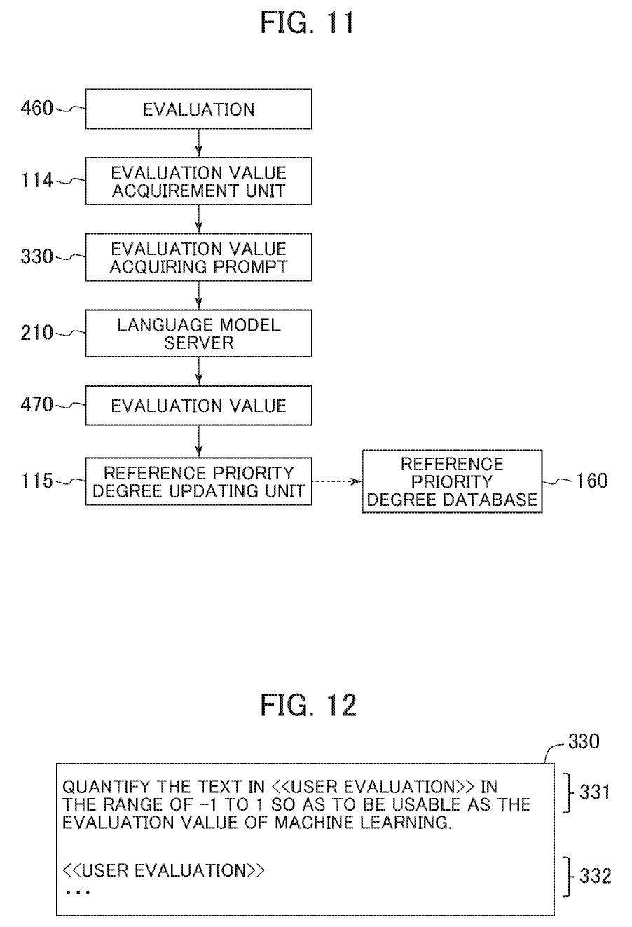

FIG. 11 is a diagram illustrating the overview of the updating process of the reference priority degree database 160 according to the second embodiment. Referring to FIG. 11, the evaluation value acquirement unit 114 and the reference priority degree updating unit 115 will be described.

### The second embodiment: The evaluation value acquirement unit

The evaluation value acquirement unit 114 acquires an evaluation 460 of the user with respect to the line configuration proposal, and converts the evaluation to an evaluation value 470. For example, the evaluation value acquirement unit 114 generates an evaluation value acquiring prompt 330 (see FIG. 12) described later, and transmits the evaluation value acquiring prompt 330 to the language model server 210 to acquire the evaluation value 470. It should be noted that the evaluation value acquirement unit 114 may be assumed to be included in the reference priority degree updating unit 115 described later.

FIG. 12 is a configuration diagram of the evaluation value acquiring prompt 330 according to the second embodiment. An element 331 includes an instruction converting the evaluation 460 in an element 332 to the evaluation value 470 of -1 to 1. The element 332 includes the evaluation 460 of the user with respect to the line configuration proposal inputted to a line configuration creation screen 340 (see FIG. 14) described later. The evaluation in FIG. 14 is “None of them are desired results.”. Thus, the evaluation 460 in the element 332 is converted to -1 that is the negative reward or the value close to -1.

### The second embodiment: The reference priority degree updating unit

Returning to FIG. 11, the reference priority degree updating unit 115 will be described. The reference priority degree updating unit 115 refers to the reference priority degree updating model 121, and updates the reference priority degree database 160. The reference priority degree updating unit 115 updates the reference priority degree database 160 on the basis of the evaluation value 470 with respect to the line configuration proposal. The line configuration proposal is generated with reference to the reference priority degree database 160 at the time of creating the line configuration proposal. Thus, the reference priority degree updating unit 115 can also be said to update the reference priority degree database 160 on the basis of the evaluation with respect to the reference priority degree database 160 at the time of creating the line configuration proposal.

As described above, the line configuration creation assistance device 100A includes the reference priority degree updating unit 115 updating the reference priority degree of the reference priority degree database 160 on the basis of the evaluation 460 with respect to the line configuration 440 obtained by inputting the input parameter 430 acquired by the parameter acquirement unit 112 to the line configuration designing device 220.

The reference priority degree updating unit 115 converts the evaluation 460 to the evaluation value 470 that is the numerical value in the predetermined range, and updates the reference priority degree by using the machining learning model (see the reference priority degree updating model 121) of the reinforcement learning technique.

The machining learning model has the state including the reference priority degree database 160, the line configuration, and the reception request, the action including the updating of the reference priority degree database 160, and the reward including the evaluation value 470.

The reference priority degree updating unit 115 (evaluation value acquirement unit 114) generates the evaluation value acquiring prompt 330 including the instruction converting the evaluation 460 to the evaluation value 470 that is the numerical value in the predetermined range, and transmits the evaluation value acquiring prompt 330 to the language model server 210 to acquire the evaluation value 470.

### The second embodiment: The reference priority degree updating process

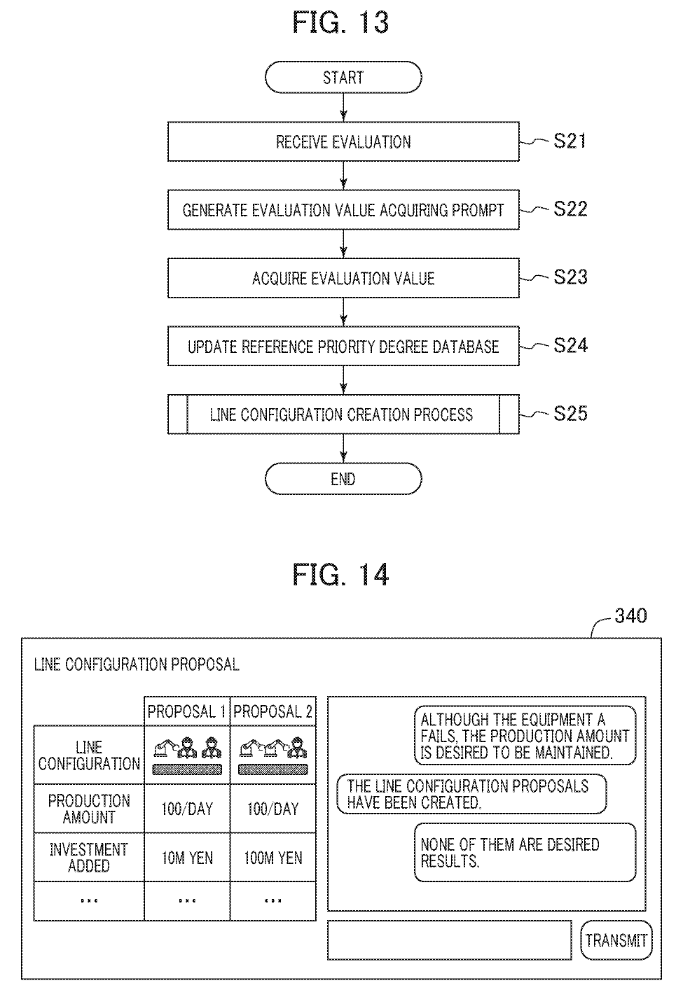

FIG. 13 is a flowchart of a reference priority degree updating process according to the second embodiment. Referring to FIG. 13, the process by which after the evaluation with respect to the line configuration proposal is inputted, the reference priority degree database 160 is updated will be represented.
In step S21, the evaluation value acquirement unit 114 acquires the evaluation 460 of the user with respect to the line configuration proposal (see FIG. 14 described later). FIG. 14 is a configuration diagram of the line configuration creation screen 340 according to the second embodiment. The user evaluates the line configuration proposals (a proposal 1 and a proposal 2) as “None of them are desired results.”.

Returning to FIG. 13, the description of the reference priority degree updating process will be continued.
In step S22, the evaluation value acquirement unit 114 generates the evaluation value acquiring prompt 330 (see FIG. 12).
In step S23, the evaluation value acquirement unit 114 transmits the evaluation value acquiring prompt 330 to the language model server 210, and acquires the evaluation value 470 as the reply.
In step S24, the reference priority degree updating unit 115 updates the reference priority degree database 160.
In step S25, the line configuration creation process (see FIG. 9) is executed. The request in this line configuration creation process is “Although the equipment A fails, the production amount is desired to be maintained.” that is the same request as before the updating of the reference priority degree database 160. By this line configuration creation process, the new line configuration proposal is created.

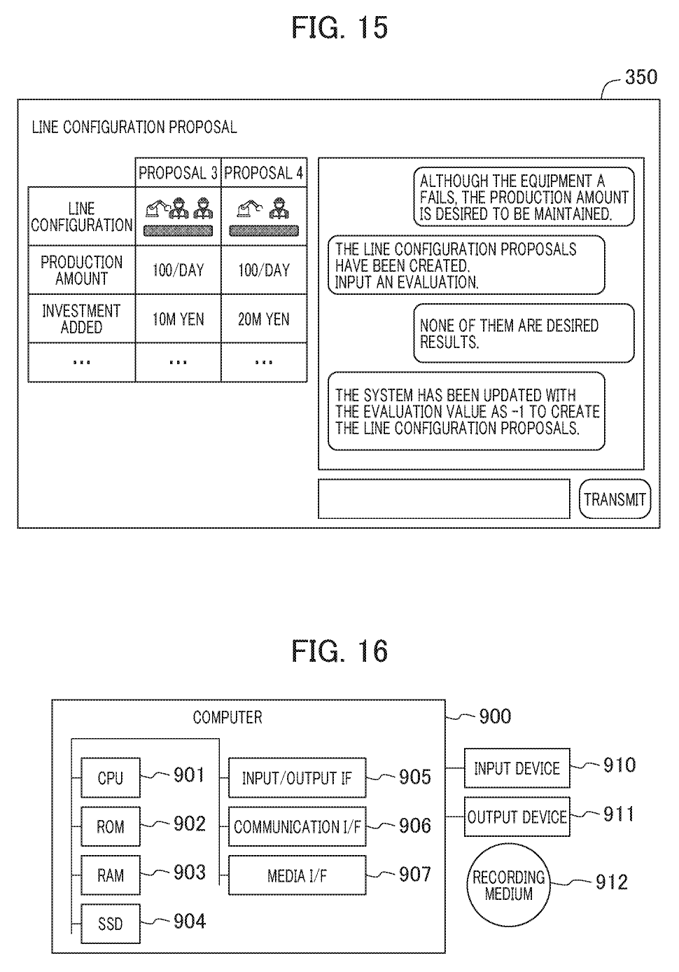

FIG. 15 is a configuration diagram of a line configuration creation screen 350 displaying the new line configuration proposal according to the second embodiment. As the new line configuration proposals, a proposal 3 and a proposal 4 are displayed.

### The second embodiment: The features of the line configuration creation assistance device

The line configuration creation assistance device 100A updates the reference priority degree database 160 on the basis of the evaluation of the user with respect to the line configuration proposal generated with reference to the reference priority degree stored in the reference priority degree database 160. By repeating the updating and the evaluation of the reference priority degree database 160, the reference priority degree database 160 is updated such that the line configuration proposal in which the evaluation is high is generated, and further, the line configuration proposal in which the evaluation is high is generated.

### Modification example: The reward

The reward for the case where the reference priority degree updating model 121 according to the second embodiment is the reinforcement learning model is the evaluation of the user with respect to the line configuration proposal. The reward may include one of the production amount in the line configuration, the number of workers in the line configuration, and the investment cost. By doing this, the updating of the reference priority degree based on various viewpoints is enabled.

As described above, the reward further includes one of the production amount in the line configuration, the number of workers in the line configuration, and the investment cost.

### Modification example: The language model server

The line configuration creation assistance devices 100 and 100A transmit the input parameter acquiring prompt 310 to the language model server 210 to acquire the input parameter proposal. In place of this, the line configuration creation assistance devices 100 and 100A may refer to the language model, and generate the input parameter proposal on the basis of the input parameter acquiring prompt 310.

As described above, the parameter acquirement unit 112 uses the language model in place of the language model server 210 to calculate and acquire the input parameter 430 on the basis of the input parameter acquiring prompt 310.

### Other modification examples

Some embodiments of the present invention have been described above, but these embodiments are illustrative only, and do not limit the technical scope of the present invention. The present invention can take other various embodiments, and further, various changes, such as omission and replacement can be made in the scope not departing from the purport of the present invention. These embodiments and the modifications thereof are included in the scope and purport of the invention described in this specification and the like, and are included in the invention described in the scope of the claims and its equivalent scope.

### Hardware configuration

For example, the line configuration creation assistance devices 100 and 100A according to the above embodiments are achieved by a computer 900 having the configuration illustrated in FIG. 16. FIG. 16 is a hardware configuration diagram illustrating an example of the computer 900 achieving the functions of the line configuration creation assistance devices 100 and 100A according to the above embodiments. The computer 900 includes a CPU 901, a ROM 902, a RAM 903, an SSD 904, and an input/output interface 905 (denoted as an input/output I/F (Interface) in FIG. 16). Further, the computer 900 includes a communication interface 906 (denoted as a communication I/F in FIG. 16), and a media interface 907 (denoted as a media I/F in FIG. 16). The computer 900 may include an HDD (Hard Disc Drive) in place of the SSD 904, and may further include an HDD in addition to the SSD 904.

The CPU 901 is operated on the basis of the program stored in the ROM 902 or the SSD 904, and performs control by the control unit 110 in FIG. 1. The ROM 902 stores the boot program executed by the CPU 901 at the time of starting the computer 900, the program related to the hardware of the computer 900, and the like.

The CPU 901 controls an input device 910 such as a mouse and a keyboard and an output device 911 such as a display and a printer via the input/output interface 905. Via the input/output interface 905, the CPU 901 acquires data from the input device 910, and outputs the generated data to the output device 911.

The SSD 904 stores the program executed by the CPU 901, the data used by the program, and the like. Via the communication network, the communication interface 906 receives the data from other device, not illustrated, (for example, the language model server 210 and the like) to output the data to the CPU 901, and in addition, transmits the data generated by the CPU 901 to other device via the communication network.

The media interface 907 reads the program or the data stored in a recording medium 912, and outputs the data to the CPU 901 via the RAM 903. The CPU 901 loads the program from the recording medium 912 onto the RAM 903 via the media interface 907, and executes the loaded program. The recording medium 912 is an optical recording medium such as a DVD (Digital Versatile Disk), a magneto-optical recording medium such as an MO (Magneto Optical disk), a magnetic recording medium, a conductor memory tape medium, a semiconductor memory, or the like.

For example, when the computer 900 functions as the line configuration creation assistance devices 100 and 100A according to the above embodiments, the CPU 901 of the computer 900 achieves the functions of the line configuration creation assistance devices 100 and 100A by executing the program 128 (see FIG. 1) loaded onto the RAM 903. The CPU 901 reads the program from the recording medium 912, and executes the program. In addition, the CPU 901 may read the program from other device via the communication network, or may install the program 128 from the recording medium 912 to the SSD 904 and execute the program 128.

What is claimed is:

1. A line configuration creation assistance device comprising:
a reference information acquirement unit referring to a line configuration designing knowledge database associating and storing a factor related to a line configuration and a solution with respect to the factor and a parameter relationship database storing a relationship between the input parameters of a line configuration designing device outputting the line configuration, and acquiring a reference solution that is the solution with respect to the factor similar to a reception request that is a received request related to the line configuration and a reference parameter that is the input parameter included in the relationship between the input parameters related to the reception request; and
a parameter acquirement unit acquiring the input parameter to the line configuration designing device satisfying the reception request on the basis of the reception request, the reference solution, the reference parameter, and a present parameter that is the input parameter to the line configuration designing device at the time of outputting the present line configuration.

2. The line configuration creation assistance device according to claim 1,
wherein the parameter acquirement unit includes
the reception request, the reference solution, the reference parameter, and the present parameter,
wherein the parameter acquirement unit refers to the reference solution to generate an input parameter acquiring prompt performing instruction to calculate the input parameter to the line configuration designing device satisfying the reception request by changing the reference parameter on the basis of the present parameter, and
wherein the parameter acquirement unit transmits the input parameter acquiring prompt to a language model server to acquire the input parameter as a reply.

3. The line configuration creation assistance device according to claim 2,
wherein the line configuration designing knowledge database is divided into one or more knowledge databases,
wherein the reference information acquirement unit refers to a reference priority degree database storing a reference priority degree that is a priority degree referring to each knowledge database for each request content that is the content of the request and a reference priority degree that is a priority degree referring to each relationship between the input parameters stored in the parameter relationship database for each request content, decides the knowledge database in which the reference priority degree with respect to the request content similar to the reception request is a predetermined value or more, and refers to the knowledge database to acquire the reference solution, and
wherein the reference information acquirement unit refers to the reference priority degree database, decides the relationship between the input parameters in which the reference priority degree with respect to the request content similar to the reception request is the predetermined value or more, and refers to the relationship between the input parameters to acquire the reference parameter.

4. The line configuration creation assistance device according to claim 3, further comprising
a reference priority degree updating unit updating the reference priority degree of the reference priority degree database on the basis of an evaluation with respect to the line configuration obtained by inputting the input parameter acquired by the parameter acquirement unit to the line configuration designing device.

5. The line configuration creation assistance device according to claim 4,
wherein the reference priority degree updating unit converts the evaluation to an evaluation value that is a numerical value in a predetermined range, and updates the reference priority degree by using a machine learning model of a reinforcement learning technique.

6. The line configuration creation assistance device according to claim 5,
wherein the machine learning model has:
a state including the reference priority degree database, the line configuration, and the reception request;
an action including the updating of the reference priority degree database; and
a reward including the evaluation value.

7. The line configuration creation assistance device according to claim 6,
wherein the reward further includes one of a production amount in the line configuration, the number of workers in the line configuration, and an investment cost.

8. The line configuration creation assistance device according to claim 1,
wherein the solution includes at least one of the changing of the line configuration, the increasing of the number of workers in the line, the reducing of the number of workers, and the replacing of the worker.

9. The line configuration creation assistance device according to claim 5,
wherein the reference priority degree updating unit generates an evaluation value acquiring prompt including an instruction converting the evaluation to the evaluation value that is the numerical value in the predetermined range, and
wherein the reference priority degree updating unit transmits the evaluation value acquiring prompt to the language model server to acquire the evaluation value.

10. The line configuration creation assistance device according to claim 2,
wherein the parameter acquirement unit uses a language model in place of the language model server to calculate and acquire the input parameter on the basis of the input parameter acquiring prompt.

11. A line configuration creation assistance method, comprising
causing the line configuration creation assistance device to execute:
while referring to a line configuration designing knowledge database associating and storing a factor related to a line configuration and a solution with respect to the factor, and a parameter relationship database storing a relationship between the input parameters of a line configuration designing device outputting the line configuration,
a step of acquiring a reference solution that is the solution with respect to the factor similar to a reception request that is a received request related to the line configuration, and a reference parameter that is the input parameter included in the relationship between the input parameters related to the reception request; and
a step of acquiring the input parameter to the line configuration designing device satisfying the reception request, on the basis of the reception request, the reference solution, the reference parameter, and a present parameter that is the input parameter to the line configuration designing device at the time of outputting the present line configuration.
